(19) United States
(12) Patent Application Publication
(10) Pub. No.: US 2023/0022638 A1
(43) Pub. Date: Jan. 26, 2023

(54) CRASH ANALYSIS DEVICE AND METHODS OF USE

(71) Applicant: MDGO Ltd., Haifa (IL)

(72) Inventors: Gilad Avrashi, Haifa (IL); Eli Zerah, Kiryat Ata (IL); Yuval Shalem, Tel-Aviv-Yafo (IL)

(21) Appl. No.: 17/788,494

(22) PCT Filed: Dec. 22, 2020
(86) PCT No.: PCT/IB2020/062361

§ 371 Date: Jun. 23, 2022

Related U.S. Application Data
(60) Provisional application No. 62/952,847, filed on Dec. 23, 2019.

(51) Int. Cl. G07C 5/08; G06Q 40/08; G07C 5/00; G01S 19/47; G01S 19/13; G01P 21/00; G01P 15/18; G01P 15/08; G01C 19/00

(52) U.S. Cl. CPC G07C 5/0841; G06Q 40/08; G07C 5/008; G01S 19/47; G01S 19/13; G01P 21/00; G01P 15/18; G01P 15/08; G01C 19/00

(57) ABSTRACT

The present disclosure relates to a contextual service device and method of use to identify an operator's needs, such as in the event a vehicle crash, vehicle breakdown, theft, and/or vehicle related quarry in real time. In various aspects, the device is self-sufficient and may be installed and activated in a single step. Furthermore, the device is not reliant upon external systems of components of the vehicle to operate and may be updated over the air to improve cash detection accuracy.

### RELATED APPLICATIONS

The present application is a Patent Cooperation Treaty (PCT) application, which claims the benefit of U.S. Provisional Application No. 62/952,847 filed on Dec. 23, 2019, the contents of which are incorporated herein in their entirety.

### FIELD OF THE PRESENT DISCLOSURE

The present disclosure generally relates to vehicle telematics systems and in particular to a self-sufficient device for contextual service analysis. More specifically, the present disclosure relates to contextual service analysis, in particular during a vehicle accident and other insurance-related cases.

### BACKGROUND OF THE PRESENT DISCLOSURE

Many vehicles are equipped with vehicle -based sensors to study vehicle crash data. These sensors, however, rely on numerous components and support systems integrated with the vehicle. Furthermore, existing sensors also rely on the end consumer to perform a number of activation steps or may require pairing the device to an external communication system. Thus, there exists a need for a self-sufficient device that does not rely on external components and systems and has a simple installation and activation process.

### SUMMARY OF PRESENT DISCLOSURE

The present disclosure generally relates to a compact, affordable, self-sufficient after-market device that is easily installed by the consumer. In various aspects, the contextual service device and/or telematics tag (“tag device”) is a self-sufficient telematics device that collects and sends sensor data in an event, which might result in the need or desire of any service, treatment, and/or assistance of a third party. The tag device is designed for use with minimal customer effort. In one aspect, the tag device is an inexpensive, disposable, and compact device, suitable for shipping via postal mail and deposit in a standard size mailbox. The tag device is operable to be installed, placed, and/or otherwise attached to a customer's vehicle and automatically activate within a few seconds (e.g. thirty seconds). The contextual service device is operable to conduct crash data analysis, learn driving profiles, and transmit to a remote server in response to car theft, hail damage, storm damage, and/or any other insurance related event.

In another aspect, the tag device can be easily installed and activated by simply engaging the device to the vehicle windshield and pulling a disposable activation tab to complete a circuit with the integrated power supply. After activation, the tag device does not require any customer involvement during the complete life span of the device, nor does the tag device receive any power from an external source or rely on any surrounding devices to collect or transmit data, such as but not limited to the customer's mobile device, an on-board diagnostics (“OBD”) port, or a controller area network bus (“CANbus”), among others.

The tag device is configured to automatically transmit data for independent contextual analysis service at a remote server, without requiring subsequent customer actions. In response to the crash data analysis, a number of crash related services may be initiated. These include, but are not limited to dispatching emergency medical services or a tow truck, directions or guidance to a repair facility based on vehicle type, make, model, year, type of damage, and/or insurance coverage, notifying an insurance agent and seamlessly initiating an insurance claim based on the crash data analysis and/or projected damage, providing predictions of likely medical needs to a user and/or local hospitals. By way of example, the tag device may also indicate to the customer that an ambulance has been dispatched. In other instances, the tag device can be configured to automatically transmit in response to a car theft, hail damage, storm damage, and/or any other insurance related event.

In one aspect, the tag device is self-sufficient and includes its own integrated power supply, processor, communication module, and sensors to collect and transmit the collected data to a remote server system for further analysis. For example, the tag device collects acceleration data and location data during a vehicle crash and transmits it instantaneously to a remote server-based crash analysis service via cellular communication or other wireless communication systems at a high resolution.

Once activated, the tag device operates in one of two system states: acquisition and transmission. When in the acquisition state, the tag device's GPS and cellular communication systems are deactivated or placed in a state of hibernation, while the accelerometer sensor is constantly recording a short buffer of data until a crash event is detected. As the tag device's GPS and/or cellular communication systems are deactivated and/or hibernating during the acquisition state, the tag device is “off-the-grid” and therefore does not and cannot monitor driving behavior and/or report driving patterns and/or behavior to third parties including, but not limited to, insurance agents, police, and/or other government agencies. Unless a crash event is detected, the buffer is over-written and the accelerometer continues to measure the acceleration or deceleration of the device, and therefore the vehicle, in real time. Conversely, the tag device enters the transmission mode upon detection of a crash and/or by manual activation by the user. The tag device turns on the internal cellular and GPS communication systems to transmit the crash data, including the raw accelerometer data and GPS location data to a remote server for further analysis. The tag device can provide a remote server (e.g. a cloud server) a status update at a predetermined interval (e.g. 24 hours) indicating proper operation. The status update can only indicate proper operation and does not and cannot provide any private information including, but not limited to, GPS data, cellular location data, driving behavior and/or the like.

### BRIEF DESCRIPTION OF THE DRAWINGS

Further features of the present disclosure will become apparent to those skilled in the art to which the present disclosure relates from reading the following specification with reference to the accompanying drawings.

FIG. 1 shows a tag device, according to at least one embodiment of the present disclosure.

FIG. 2 is a block diagram of the component of a tag device, according to at least one embodiment of the present disclosure.

FIG. 3 is a diagram of a tag device as installed on a vehicle according to one embodiment of the present disclosure.

FIG. 4 is a flow chart of a method of installing and using a tag device, according to at least one embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series, and the like.

The present disclosure is drawn to device sensors designed to provide data for crash analysis. As such, the device sensors can have a dynamic range, sampling frequency, and/or buffer size tailored to meet low to severe crash pulse (accelerations) characteristics. The device can also have the advantage of not collecting any data other than in the event of a crash. This has advantages both in energy consumption and/or in customer privacy.

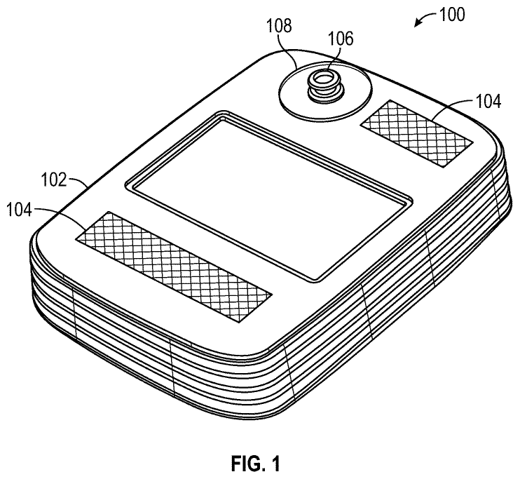

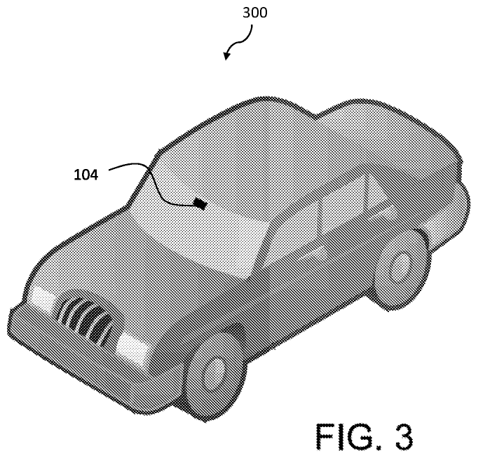

FIG. 1 illustrates a perspective view of a tag device, according to at least one instance of the present disclosure. A tag device 100 can include a housing 102 that supports a plurality of other sensors, modules, components, and/or power supplies within the device. The tag device 100 is a compact device that may be easily shipped to a customer and mounted in an inconspicuous and/or non-obstructive location. In at least one embodiment, the tag device may have a length of less than or equal to approximately three inches, a width less than or equal to approximately 2 inches, and a depth less than or equal to approximately one inch. In other instances, the tag device may have other dimensions. The housing may further include and/or be engaged with one or more adhesives 104 that adhere the tag device 100 to the customer's vehicle. In other aspects, the tag device may be engaged with the windshield using suction cups and/or other removable engagement mechanisms; however, a removable adhesive is preferred as it minimizes vibrations. When shipped, the adhesive 104 may be initially covered by a removable film (not shown), that is removed by the customer before placing the tag on the vehicle. While the tag device 100 may be adhered anywhere in the interior of the vehicle, the device is preferable mounted on an interior surface of the windshield, as shown in FIG. 3.

The tag device 100 can also include a soft switch 106 arranged adjacent to the one or more adhesives 104 and on substantially the same surface operable to engage the customer's vehicle. The soft switch 106 can be operable to compress, deform, deflect, and/or otherwise activate when the tag device 100 is installed. The soft switch 106 can be arranged to automatically activate the tag device 100 upon installation. In other arrangements, the tag device 100 can have a soft switch 106 disposed on a surface accessible to a customer, allowing manual activation by customer. In yet other instances, the tag device 100 can have more than one switch including, but not limited to, the soft switch 106 operable to compress, deform, deflect, and/or otherwise activate upon installation and/or a soft switch disposed on surface accessible to a customer after installation, thus requiring activation of each switch prior to complete activation of the tag device 100.

The soft switch 106 can have a blister and/or protective cap 108 disposed substantially over the soft switch 106 during shipping and/or storage to prevent accidental activation. The protective cap 108 can form substantially rigid protection over and/or around the soft switch 106 to prevent accidental compression, deformation, and/or other activation of the soft switch. In at least one instance, the protective cap 108 can be a partial sphere disposed over and/or around the soft switch 106. In other instances, the protective cap 108 can be a cube shape, cylinder, and/or other shape operable to prevent accidental activation of the soft switch 106.

The protective cap 108 can be removable immediately prior to installation to the vehicle, thus allowing activation of the tag device 100 as desired by the customer. The protective cap 108 can be removably coupled via non-residue adhesive, tape, or similar arrangement to allow a customer to remove the protective cap just prior to or during installation.

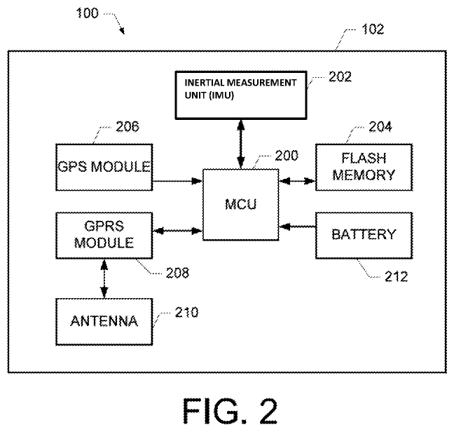

FIG. 2 illustrates a diagrammatic view of one or more components of the tag device, according to at least one instance of the present disclosure. The tag device 100 can include a processer and/or processing system 200, such as a microcontroller unit (MCU). As shown, the processor 200 may communicate directly and/or indirectly with an Inertial Measurement Unit (IMU) 202, memory 204, a global positioning system (“GPS”) module 206, a cellular transceiver module 208, an antenna 210, and a power supply 212. In other aspects, the tag device 100 may optionally include a gyroscope, magnetometer, compass, microphone, image sensor, and/or a speaker (not shown).

The processor 200 may be any type of computer, controller, microcontroller, circuitry, chipset, microprocessor, processor system, or computer system, that is operable to perform algorithms, to execute software applications, to execute sub-routines and/or to be loaded with and to execute any other type of computer program.

In one aspect, the IMU 202 can include a multi-axis accelerometer, such as a two-axis or three-axis accelerometer. The IMU 202 can also include a gyroscope, which can be implemented to determine the orientation of the tag device 100 and/or corresponding orientation relative to accelerometer data, thereby calibrating the tag device 100 and the tag device's crash detection ability. In at least one embodiment, the IMU 202 can be configured to measure changes in motion in an x-axis, y-axis, and z-axis of the vehicle. The IMU 202 can be operable to calibrate the tag device 100 by assessing the orientation of the tag device 100 relative to a vehicle's orientation system upon which the tag device 100 is installed. In order to determine if a crash event occurs, the IMU 202 can continuously monitor and/or poll the data collected by the IMU to identify changes in acceleration that are indicative of a vehicle crash. In at least one instance of the present disclosure, the IMU can include means for processing acceleration data, such that if the IMU 202 detects and/or identifies acceleration data indicative of a vehicle crash, the IMU 202 can wake the processor 200 to transition from an acquisition mode to an operation mode. In one aspect, the processor 200 may make a preliminary determine that a crash event has occurred when an acceleration and/or deceleration is greater than a pre-selected, yet variable, acceleration threshold value.

In at least one instance of the present disclosure, the tag device 100 can be operable to learn a driving profile of a vehicle. The driving profile of the vehicle can be implemented for insurance underwriting, and/or the like. The IMU 202 can be operable to collect data while the vehicle is operating to develop the driving profile. In at least one instance, the tag device 100 can be operable to determine the vehicle is in motion and collection overall driving time during a predetermined period of time. This information can be utilized to develop a “pay-as-you-drive” insurance policy. In other instances, the IMU 202 can be operable to collect driving behavior including, but not limited to, acceleration data, driving time, driving speed, and/or the like, which can be analyzed by a predetermined algorithm to produce a driving grade and/or score, thereby producing a “pay-how-you-drive” insurance policy. In yet other instances, the tag device 100 can implement the pay-as-you-drive and/or the pay-how-you-drive data collection continuously and/or a predetermined period of time (e.g. days, weeks, months, etc.).

According to one aspect, the memory 204 may be any non-transitory computer-readable storage media that stores and provides data to the processor 200. By example and not limitation the memory 204 may be flash memory. The memory 204 also acts buffer memory, as the processor 200 continuously reads and overwrites data related to non-crash accelerations.

The GPS module 206 includes a GPS receiver that receives wireless signals from a network of orbiting GPS satellites through an integrated antenna (not shown) which are processed at an integrated microprocessor (not shown). Typically, the GPS module 206 receives signals from at least three satellites in the GPS network from which the microprocessor can determine precise location data and motion data of the module and tag device 100. The location data and motion data are then provided to the processor 200. In various aspects, the GPS module 206 is configured to generate the location data at a desired interval. For example, the location data for the tag device 100 may be generated every 10 seconds, every thirty seconds, every minute, among others.

The cellular transceiver module 208 includes the antenna 210 and other hardware and software for communication through a variety of cellular networks. By way of example and not limitation, the cellular network may be a Code Division Multiple Access (CDMA), a Global System for Mobiles (GSM), General Packet Radio Service (GPRS) network, 3G, 4G, and/or a 5G networks. The cellular transceiver module 208 can include a physical Subscriber Identification Module (SIM) card and/or an electronic SIM (e-SIM),

The power supply 212 is integrated into the tag device 100 and provides all the power to the components of the tag device. In various aspects, the power supply may include a solar panel on an exterior surface of the tag device. The tag device 100 can be a soft switch (e.g. soft switch 206) operable to activate the device upon installation. The power supply 212 can be operable to provide minimal power prior to activation, and provide operational power upon activation and/or installation of the tag device 100.

In other instances, upon installation, the customer can activate the tag device 100 to provide power to the components therein. In one aspect the customer removes a non-conductive tab (not shown) to complete a circuit between the power supply 212 and the processor 200 thus activating the tag device 100. In this arrangement, the power supply 212 is isolated from each component prior to removal of the tab. In another aspect, the customer may actuate a switch or button to power the device. Other suitable means may be used to energize the device after installation and remain energized without customer intervention. The tag device 100 only requires activation and powers on once, either via installation with the soft switch or via removal of the non-conductive tab. Thereafter, the tag device 100 functions without intervention from the customer and/or user.

The tag device 100 can have one or more points of contact 214 operable to allow the customer and/or user to activate a service call manually, without the need for crash detection. The one or more point of contact 214 can allow the customer to input a predetermined sequence of activation to request one or more services including, but not limited to, an emergency call to a public safety access point (PSAP), a request for roadside assistance, a request for a tow truck, an insurance provider's call center, a customer interface, mobile application (e.g. insurance carrier application, roadside assistance application, and/or native application), and/or the like. In at least one instance, the one or more point of contact 214 can also act as a dedicated emergency button operable to engage the tag device 100 without the need for crash detection via the IMU 202 (e.g. for a third party accident independent of the customer's vehicle).

The one or more points of contact 214 can further be implemented to allow a user to request information from the vehicle tag 100. The one or more points of contact 214 can be actuated in a predetermined pattern allowing the customer to request crash analysis and/or crash data from the vehicle tag 100. In at least one instance, the customer can request crash analysis and/or crash data from the vehicle tag 100 can be communicated to a defined contact via SMS and/or a mobile application.

One or more heat sensors 216 can also be coupled with the tag device 100 and operable to detect a fire within the vehicle. The one or more heat sensors 206 can be operable to determine the presence of a fire and/or request the processor 200 initiate fire emergency response. In at least one instance, the processor 200 can request data from the one or more heat sensors upon detection of a crash event by the IMU 202. In other instances, the one or more heat sensors 206 can provide the processor 200 with data irrespective of IMU 202 data and/or acceleration data.

A microphone 218 can be communicatively coupled with the tag device and be operable to detect crash events in conjunction with and/or independent of the IMU 202. The microphone can be operable to receive ambient sound (audible frequency ranges and/or inaudible frequency ranges) from the vehicle. The crash detection algorithm can determine if the sound patterns detected by the microphone 218 are indicative of a crash event.

In other instances, the microphone 218 can allow interaction and/or communication with the user. The microphone 218 can receive requests for claim status of prior crash detection, estimated time of arrival for third party services (e.g. tow truck, ambulance), and/or allow real time communication with first responders via the cellular transceiver module 208. In at least one instance, the microphone 218 can be operable to trigger with a predetermined phrase and/or word to allow a user to provide requests.

FIG. 3 illustrates a tag device installed on a vehicle, according to at least one instance of the present disclosure. The tag device 100 can be removably coupled with a vehicle 300 and operably positioned to detect crash analysis information of the vehicle 300 upon which the tag device is installed 100. In at least one instance of the present disclosure, the tag device 100 is operably coupled with a windshield 302 of vehicle 300.

As discussed with respect to FIG. 1, the tag device 100 can include a soft switch 106 that is operable to be compressed and/or otherwise engaged when the tag device is installed 100 on the vehicle 300. The soft switch 106 can be compressed as the tag device 100 is coupled with the windshield 302 by the adhesives 104. Compression and/or other engagement of the soft switch 106 can activate the tag device 100, thereby completing installation of the vehicle tag 100.

While FIG. 3 illustrates the tag device 100 operably coupled with the lower left-hand side portion of the windshield, it is within the scope of the present disclosure to implement the tag device 100 at any location on the windshield 302 that does not provide a visual obstruction. In some instances, the tag device 100 can be positioned in the upper right-hand side of the windshield 302, behind a rearview mirror, or other locations on the windshield 302.

Further, while the present disclosure illustrates the tag device 100 coupled with the windshield 302 of the vehicle 300, it is within the scope of the present disclosure to implement the tag device 100 in any securable, accessible location of the vehicle 300. In at least one instance, the tag device 100 can be coupled with at least a portion of the dashboard of the vehicle 300. In other instances, the tag device 100 can be couplable with a body panel (e.g. trunk lid, door panel, A-pillar, B-Pillar, etc.) of the vehicle 300.

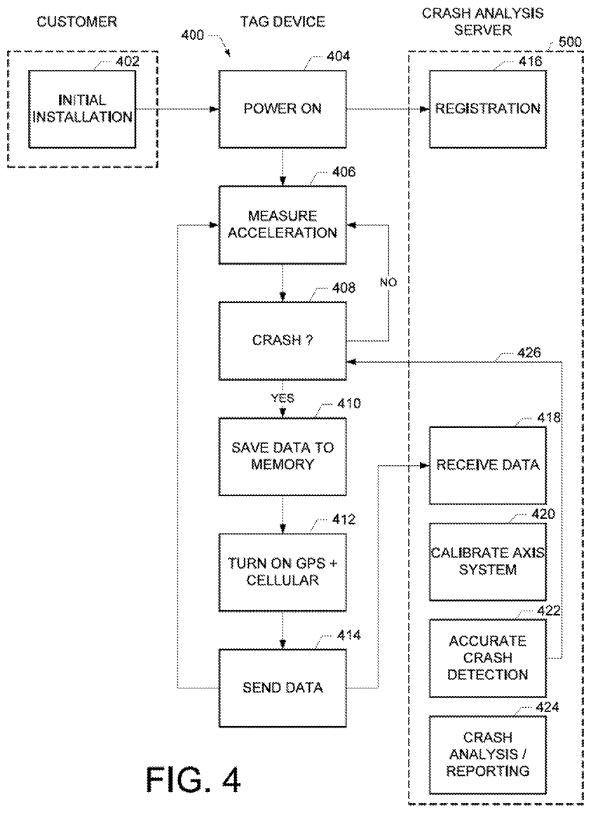

A method 400 of performing crash analysis using the tag device 100 is shown in FIG. 4. As previously described after installing the tag device in a vehicle and activating the device, shown as block 402, the tag device is now powered, activated, and in an acquisition mode, ready to measure acceleration of the vehicle as indicated by block 404. As similarly previously discussed, the tag device 100 can be stored, shipped, and/or received in a pre-activation mode operable to preserve battery life. The pre-activation mode can include having one or more components of the tag device 100 in an off configuration and the microprocessor in a low-energy mode awaiting activation. The activation can occur either by manual user control (e.g. via switch, button, etc.) and/or automatically during installation via a soft switch 106.

Optionally, the accelerometer may be calibrated after activation. In one aspect, the calibration is performed without customer interaction and occurs during the first few hours or days of use. Subsequent calibration may occur automatically at periodic intervals. In at least one instance, the IMU 202 and/or the gyroscope can be implemented and/or utilized to assist in calibration of the accelerometer after installation and/or automatically at the periodic intervals. At block 406, the IMU 202 captures acceleration data for the vehicle along three axes and transmits the data to the processor 200.

The processor 200 can analyze the acceleration data to determine if the measured acceleration data alone likely indicates that a vehicle collision or crash has occurred at block 408. Alternatively, in embodiments of the tag device 100 that include a gyroscope, measurements made at the gyroscope may also be used to determine if a crash has occurred in conjunction with and/or independent of the acceleration data. In one aspect, the processor 200 determines that a collision occurs when the IMU 202 receives acceleration data in at least one axis exceeds acceleration threshold data. If the IMU data does not exceed the acceleration threshold and/or a gyroscope measurement threshold, then the processor remains in the acquisition mode and the method returns to block 406 where additional acceleration data is measured.

If the measured acceleration data exceeds the acceleration threshold, the processor 200 can transition to an operation mode and acceleration data can be saved to the memory 204 at block 410. In various aspects of the present disclosure, the acceleration threshold may be adjusted through “over the air” updates 426, in response to further analysis of the potential crash accelerations that were determined to be false positive results. As such, the acceleration threshold may be lowered to increase the range of measured acceleration data that is classified as a crash. Alternatively, the acceleration threshold may be increased, thus decreasing the range of measured acceleration data that is classified as a crash.

In at least one instance of the present disclosure, the processor 200 and/or the tag device 100 can have two or more acceleration thresholds. A high threshold can be implemented for event detection and communication with the server, and a low threshold for minor events can be stored and sent for processing at a later time. The tag device 100 can detect, record, and/or store locally events that exceed the low threshold and transmit the minor events at a predetermined period of time, or upon detection of an event that exceeds the high threshold. The high threshold can be representative of a vehicle crash, while the low threshold can be representative of a hitting a road hazard (e.g. pothole).

The tag device 100 can provide the cloud server and/or remote service system a ping and/or status update at predetermined time interval to ensure functionality of the tag device 100. In at least one instance, the cloud server and/or remote service system can request a status of functionality of the tag device 100 on a 24-hour time interval. The status of functionality can indicate a battery level, error codes, and/or overall status of the tag device 100.

The tag device 100 can further be operable to provide status update to a user, user's device, and/or the remote server indicating a low battery level. The tag device 100 and/or the remote server can indicate to the user replacement of the device is necessary and/or automatically ship a replacement tag device, thereby preventing an interruption in service to the user. In at least one instance, the battery of the tag device 100 can be user-replaceable and the operational status can indicate the battery requires replacement.

When a potential crash is identified and/or otherwise indicated (e.g. manual user activation, requested to a customer due to potential theft, etc.), the processor 200, in the operation mode, can initialize the GPS module 206 and/or the cellular transceiver module 208 at block 412 to capture location data and to transmit the location data from the tag device to a remote server for subsequent analysis and crash response actions at block 414. After this transmission, the processor 200 returns to the acquisition mode and continues to receive accelerometer data at block 406.

As shown, when using the tag device 100, the customer may optionally register the tag device 100 with a crash analysis server 500 at block 416 that performs data analysis on the data from the tag receiver in order to provide the customer with a variety of services and/or to initiate emergency responses if necessary. The tag device 100 can be operable to indicate to the customer the initiation of emergency response through an audible signal, visual signal, and/or combination thereof. The tag device can provide a flashing LED and/or an audible beeping sound in a predetermined pattern to indicate to a customer that emergency response has been initiated. In at least one instance, the tag device 100, as discussed with respect to FIG. 2, can be operable to detect a fire via one or more heat sensors and dispatch a fire rescue team in conjunction with and/or independent of other emergency response.

At block 418, the crash analysis server 500 receives at least the acceleration data and/or the location data from the tag device 100. The crash analysis server calibrates the acceleration data, if necessary, by aligning the axes system of received data at block 420. The crash analysis server also analyzes the acceleration data using a variety of more robust algorithms and thresholds than those performed at the processor 200 in order to reduce false positive crash identifications at block 422. By way of example, after the initial on-board crash detection at the tag device 100 and a final crash detection decision at the server, data, and statistics regarding previous crash events that were analyzed at the server and ultimately classified as non-crash events are used to adjust the acceleration threshold at the tag device accordingly.

Based at least in part on the results of the in-depth analysis at the crash analysis server 500, the server may initiate further communication to dispatch emergency medical services, dispatch a tow truck, contact an insurance agent for the customer, or provide predictions of medical needs to local medical facilities at block 424. In at least one aspect of the present disclosure, the server may send injury prediction and/or damage assessment to the relevant insurance company for efficient claim management and rapid claim settlement for the customer. In another aspect of the present disclosure, the server may initiate a driver alert that an ambulance has been requested and/or is en route. Such an alert may be made via a light indication and/or audible signal emanating from the tag device 100.

Various forms of transmission media may be involved in carrying one or more sequences of data or one or more instructions to the processor 200 for execution. A bus carries the data and instructions to and from the system RANI, which may be within the memory 204, and the processor 200 that executes the instructions. Although not shown, the various components 200-212 tag device 100 may be connected via a single bus. However, in other aspects, the components may be connected through one or more data transport means. For example, the processor 200 and memory 204 may be connected via a local microprocessor bus, while the other components may be connected via one or more input/output (I/O) buses.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology has been presented for purposes of illustration and description. It is not intended to be exhaustive or to limit the technology to the precise form disclosed. Many modifications and variations are possible in light of the above teaching. The described embodiments were chosen to explain the principles of the technology, its practical application, and to enable others skilled in the art to utilize the technology in various embodiments and with various modifications as are suited to the particular use contemplated. It is intended that the scope of the technology be defined by the claim.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

1. A portable self-sufficient contextual service device comprising:
a housing;
a processor disposed within the housing and in communication with a memory disposed within the housing;
an Inertial Measurement Unit (“IMU”) including at least a multi-axis accelerometer disposed within the housing, the multi-axis accelerometer configured to detect an acceleration of the device in one or more axis and to generate and transmit an acceleration signal indicative of the acceleration to the processor;
a GPS receiver in communication with the processor and configured to generate and transmit a location signal indicative of a location for the device;
a communication device in communication with the processor and configured to receive and transmit data over a cellular network; and,
a power supply disposed within the housing.

2. The contextual service device of claim 1, wherein the contextual service device is engaged to an interior surface of a vehicle.

3. The contextual service device of claim 2, wherein the housing includes an adhesive for removably engaging the contextual service device to the interior surface.

4. The contextual service device of claim 1, wherein the memory stores acceleration threshold data that is received at the processor to determine if the acceleration signal is indicative of a vehicle crash.

5. The contextual service device of claim 4, wherein the processor is configured to generate a crash signal indicative of a vehicle collision when the processor determines that the acceleration signal exceeds the acceleration threshold data; and wherein the crash signal is transmitted by communication device to a remote server.

6. The contextual service device of claim 1, wherein the processor receives over the air updates via the communication device.

7. The contextual service device of claim 1, wherein the IMU further comprises a gyroscope.

8. The contextual service device of claim 7, wherein the gyroscope is operable to calibrate the multi-axis accelerometer relative to a vehicle's axis system.

9. The contextual service device of claim 1, further comprising one or more heat sensors operable to detect fire within the vehicle.

10. A method for using a self-sufficient contextual service device mounted in a vehicle; the method comprising:
initializing the contextual service device by providing power to the contextual service device from an internal power supply;
measuring acceleration data at an Inertial Measurement Unit (IMU) including a multi-axis accelerometer mounted within the contextual service device;
processing the acceleration data at the IMU, a processor, or both the IMU and the processor of the crash detection device; wherein the IMU, the processor, or both the IMU and the processor determines if the acceleration data is indicative of a vehicle event;
wherein if the processor determines that there is not a vehicle event, acquiring additional acceleration data; and
wherein if the processor determines that there is a vehicle event:
storing the acceleration data in memory;
initializing a GPS receiver and communication device disposed within the contextual service device;
receiving location data at the processor from the GPS receiver;
transmitting the acceleration data and location data through the communication device to a remote server.

11. The method for using a self-sufficient contextual service device of claim 10, further comprising: receiving a manual activation indicating a vehicle event.

12. The method for using a self-sufficient contextual service device of claim 10, further comprising:
transmitting an operation status of the contextual service device to the remote server.

13. The method for using a self-sufficient contextual service device of claim 10, wherein the method further comprises mounting the contextual service device on a windshield of the vehicle.

14. The method for using a self-sufficient contextual service device of claim 13, wherein the method further comprises activating the contextual service device via deformation of a soft switch when the contextual service device is mounted on the windshield.

15. The method for using a self-sufficient contextual service device of claim 10, wherein the IMU further comprises a gyroscope.

16. The method for using a self-sufficient contextual service device of claim 15, wherein the gyroscope is operable to calibrate the multi-axis accelerometer relative to a vehicle's axis system.

17. The method for using a self-sufficient contextual service device of claim 10, wherein the contextual service device includes one or more heat sensors operable to detect a fire, wherein if the processor determines that there is a vehicle event:
receiving heat signature data from the one or more heat sensors, and reporting a fire to a fire emergency service if the heat signature data is indicative of a fire.

18. The method for using a self-sufficient contextual service device of claim 10, wherein the contextual service device includes a microphone operable to detect sound waves, wherein the processor operable to determine if the sound waves are indicative of a vehicle event.

19. The method for using a self-sufficient contextual service device of claim 18, wherein the microphone is operable to detect sounds waves in a frequency range between about 10 Hz to about 100 kHz.

20. The method for using a self-sufficient contextual service device of claim 10, further comprising:
receiving a request, from a user, for a stored acceleration data indicative of a event stored by the processor in the memory; and
communicating the stored acceleration data to a predetermined contact.

21. The method for using a self-sufficient contextual service device of claim 10, wherein the processor determines if the acceleration data is indicative of a vehicle event by comparing the acceleration data to acceleration threshold data.

22. The method for using a self-sufficient contextual service device of claim 10, wherein the method further comprises updating acceleration threshold data stored in the memory.

23. The method for using a self-sufficient contextual service device of claim 10, further comprising:
registering the contextual service device at the remote server;
calibrating axis data of the acceleration data received at the remote server;
performing additional contextual service analysis at the remote server; and
reporting a vehicle event to at least one of: emergency medical services, a tow service, an insurance service, a medical facility.
